(19) United States
(12) Patent Application Publication
(10) Pub. No.: US 2016/0141746 A1
(43) Pub. Date: May 19, 2016

(54) ELECTRONIC DEVICE INCLUDING ANTENNA

(71) Applicant: Samsung Electronics Co., Ltd., Gyeonggi-do (KR)

(72) Inventors: Geunwoo KIM, Gyeonggi-do (KR); Hyun KIM, Seoul (KR); Minho SOH, Gyeonggi-do (KR); Changgwon CHUNG, Gyeonggi-do (KR)

(73) Assignee: Samsung Electronics Co., Ltd.

(21) Appl. No.: 14/940,402

(22) Filed: Nov. 13, 2015

(30) Foreign Application Priority Data
Nov. 13, 2014 (KR) 10-2014-0157845

(51) Int. Cl. H01Q 1/27; H01Q 1/50

(52) U.S. Cl. CPC H01Q 1/273; H01Q 1/50

(57) ABSTRACT

An electronic device is provided. The electronic device includes a body including a communication module, and at least one first conductive contact configured to transmit electrical signals to and receive electrical signals from the communication module; and at least one strap removably connected to the body, the at least one strap including an antenna therein, and at least one second conductive contact configured to transmit electrical signals to and receive electrical signals from the antenna, the one strap being configured to removably connect to the body, such that at least a portion of the at least one first conductive contact is electrically connected to the at least one second conductive contact.

### PRIORITY

This application claims priority under 35 U.S.C. §119(a) to Korean Patent Application Serial No. 10-2014-0157845, which was filed in the Korean Intellectual Property Office on filed on Nov. 13, 2014, the entire disclosure of which is incorporated herein by reference.

### BACKGROUND

1. Field of the Invention

The present invention relates generally to a structure of an electronic device including an antenna.

2. Description of the Prior Art

An aspect of the electronic device market that has focused on the miniaturization and light weight of electronic devices, such as smartphones and tablet PCs, has recently expanded to the wearable device market for increasing the portability of electronic devices for the user. Since wearable devices, such as eyeglasses, watches, and clothes, can be worn on the body of the user, wearable devices are able to provide functions of existing smart electronic devices, such as a data communication function, while being more portable than other existing smart devices. Therefore, wearable devices can provide various convenient functions.

The wearable devices may include an antenna to support a communication function, for example, a voice call function or a data communication function. However, in contrast to other existing electronic devices such as smartphones, antennas of wearable devices antennas are limited due to shapes, sizes, and materials thereof. Furthermore, when different frequency bands are used in different nations to perform certain functions, a single electronic device used in various nations may include a plurality of various antennas and/or antenna patterns. However, due to limits resulting from restrictions on the outer size and shape of wearable devices (e.g., the size and shape of a smartwatch), in may be difficult to include antennas and antenna patterns for different nations in wearable devices.

### SUMMARY

The present invention has been made to address at least the problems and/or disadvantages described above and to provide at least the advantages described below.

Accordingly, an aspect of the present invention is to provide a method of developing an antenna in a wearable device that has a limited space.

In accordance with an aspect of the present invention, an electronic is provided. The electronic device includes a body including a communication module, and at least one first conductive contact configured to transmit electrical signals to and receive electrical signals from the communication module; and at least one strap removably connected to the body, the at least one strap including an antenna therein, and at least one second conductive contact configured to transmit electrical signals to and receive electrical signals from the antenna, the one strap being configured to removably connect to the body, such that at least a portion of the at least one first conductive contact is electrically connected to the at least one second conductive contact.

In accordance with another aspect of the present invention, an electronic device is provided. The electronic device includes a body including a communication module, and a first connector having at least one conductive contact configured to transmit electrical signals to and receive electrical signals from the communication module; at least one strap comprising an antenna, and a second connector having at least one second conductive contact configured to transmit electrical signals to and receive electrical signals from the antenna; and a coupling unit configured to removably couple the first and second connectors, and further configured to electrically connect at least a portion of the at least one first conductive contact to at least a portion of the at least one second conductive contact.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a diagram illustrating a network environment including an electronic device according to an embodiment of the present invention;

FIG. 2 is a block diagram illustrating an electronic device according to an embodiment of the present invention;

FIG. 3 is a block diagram of a program module according to various embodiments of the present invention;

FIG. 4 is a diagram illustrating a perspective view of an electronic device according to various embodiments of the present invention;

FIG. 5 is a diagram illustrating a plan view of an electronic device according to an embodiment of the present invention;

FIG. 6 is a diagram illustrating a plan view of an electronic device according to an embodiment of the present invention;

FIG. 7 is a diagram illustrating a plan view of an electronic device according to an embodiment of the present invention;

FIG. 8 is a diagram illustrating a plan view of an electronic device according to an embodiment of the present invention;

FIG. 9A is a diagram illustrating a side view of an electronic device according to an embodiment of the present invention; and

FIG. 9B is a diagram illustrating a side view of an electronic device according to an embodiment of the present invention.

### DETAILED DESCRIPTION OF EMBODIMENTS

Hereinafter, various embodiments according to the present disclosure are described with reference to the accompanying drawings. The present disclosure may have various embodiments, and modifications and changes may be made therein. Therefore, the present invention will be described in detail with reference to particular embodiments shown in the accompanying drawings. However, there is no intent to limit the present disclosure to the particular forms, and the present disclosure should be construed to cover all modifications, equivalents, and/or alternatives falling within the spirit and scope of the present invention. In describing the drawings, the same or similar elements may be designated by the same or similar reference numerals.

Herein, the terms “include” and “may include” refer to the existence of a corresponding function, operation, or constituent element, and do not limit one or more additional functions, operations, or constituent elements. Further, terms such as “include” or “have” may be construed to refer to a certain characteristic, number, step, operation, constituent element, component or a combination thereof, but are not to be construed to exclude the existence of or a possibility of addition of one or more other characteristics, numbers, steps, operations, constituent elements, components or combinations thereof.

Further, the terms “or”, “at least one of”, and “and/or” include any or all combinations of words enumerated together. For example, the expression “A or B” may include A, may include B, or may include both A and B.

While terms including ordinal numbers, such as “first” and “second”, may be used in herein to modify various constituent elements, such constituent elements are not limited by the above terms. For example, the above terms do not limit the sequence and/or importance of the corresponding constituent elements. The above terms are used merely for the purpose of distinguishing a constituent element from other constituent elements. For example, the terms “a first user device” and “a second user device” indicate different user devices although both devices are user devices. For example, a first constituent element may be referred to as a second constituent element, and likewise a second constituent element may also be referred to as a first constituent element without departing from the scope of the present invention.

When a component is referred to as being “connected” to or “accessed” by any other component, the component may be directly connected to or accessed by the other component. Further, one or more other new components may also be interposed between them. By contrast, when a component is referred to as being “directly connected” or “directly accessed” to any other component, no other new components are connected between the component and the other component.

The terms as used herein with reference to various embodiments of the present invention are merely used for the purpose of describing particular embodiments, and are not intended to limit the present disclosure. Singular forms are intended to include plural forms unless the context clearly indicates otherwise.

Unless defined otherwise, all terms used herein, including technical terms and scientific terms, have the same definitions as commonly understood by a person of ordinary skill in the art to which the present disclosure pertains. Terms defined in a generally used dictionary are to be interpreted to have the meanings equal to the contextual meanings in the relevant field of art, and are not to be interpreted to have ideal or excessively formal definitions unless clearly defined in the present disclosure.

An electronic device according to the present disclosure may include a communication function. For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and/or a wearable device (e.g., a head-mounted-device (HMD) such as electronic glasses, electronic clothes, an electronic bracelet, an electronic necklace, an electronic appcessory, electronic tattoos, or a smartwatch).

According to some embodiments of the present invention, the electronic device may be a smart home appliance with a communication function. A smart home appliance, as an electronic device according to embodiments of the present invention, for example, may include a television, a digital video disk (DVD) player, an audio, a refrigerator, an air conditioner, a vacuum cleaner, an oven, a microwave oven, a washing machine, an air cleaner, a set-top box, a television (TV) box (e.g., Samsung HomeSync™, Apple TV™, or Google TV™), a game console, an electronic dictionary, an electronic key, a camcorder, and/or an electronic photo frame.

According to some embodiments of the present invention, the electronic devices may include at least one of various medical devices (e.g., magnetic resonance angiography (MRA), magnetic resonance imaging. (MRI), computed tomography (CT), and ultrasonic machines), navigation equipment, a global positioning system (GPS) receiver, an event data recorder (EDR), a flight data recorder (FDR), an automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) device in a shop.

According to some embodiments of the present invention, the electronic device may include at least one of a part of furniture or a building/structure, an electronic board, an electronic signature receiving device, a projector, and various kinds of measuring instruments (e.g., a water meter, an electric meter, a gas meter, and a radio wave meter). An electronic device according to the present disclosure may be a combination of one or more of the aforementioned various devices. Further, the electronic device according to the present disclosure may be a flexible device. Further, the electronic device according to the present disclosure is not limited to the aforementioned devices.

Hereinafter, electronic devices according to various embodiments of the present invention are described herein with reference to the accompanying drawings. The term “a user” as used in various embodiments may refer to any person who uses an electronic device or any other device (e.g., an artificial intelligence electronic device) using an electronic device.

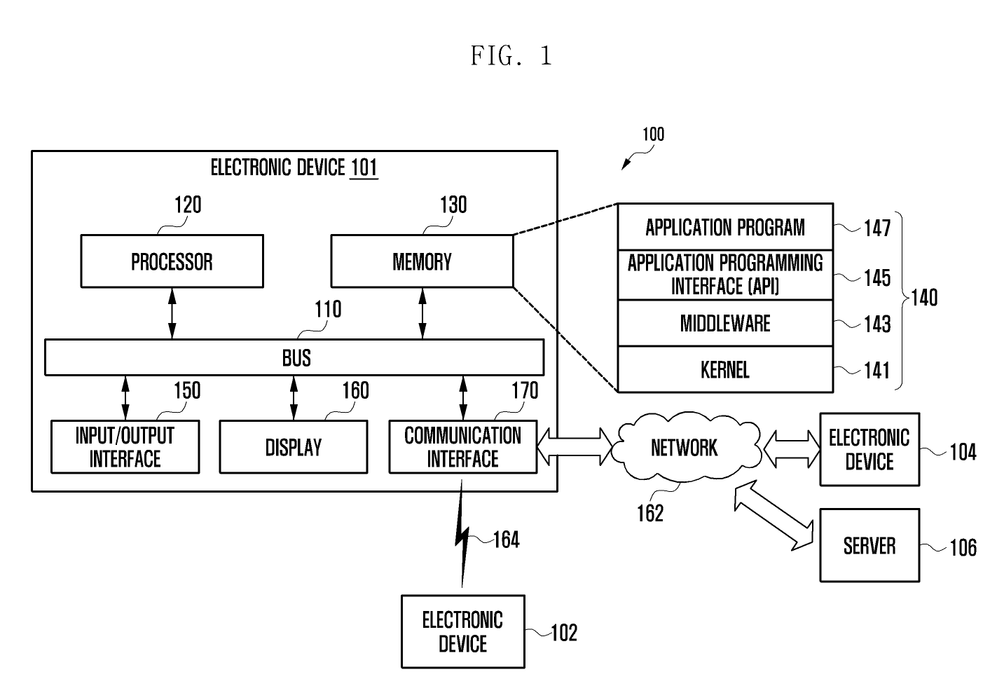

FIG. 1 is a diagram illustrating a network environment including an electronic device according to an embodiment of the present invention.

Referring to FIG. 1, a network environment 100 includes an electronic device 101 according to various embodiments of the present invention. The electronic device 101 includes a bus 110, a processor 120, a memory 130, an input/output interface 150, a display 160, a communication interface 170, and an application control module.

The bus 110 may be a circuit interconnecting the aforementioned components and transmitting communication (e.g., a control message) between the aforementioned components.

The processor 120, for example, may receive instructions from the memory 130, the input/output interface 150, the display 160, the communication interface 170, and the application control module) other than the processor 120 through the bus 110. Then, the processor 120 may decode the received instructions and perform operations or data processing according to the decoded instructions.

The memory 130 may store instructions or data received from or generated by the processor 120 or other components, such as the input/output interface 150, the display 160, the communication interface 170, and the application control module. The memory 130 includes one or more programming modules 140 including, for example, a kernel 141, middleware 143, an application programming interface (API) 145, and applications 147. Each of the programming modules as described above may be formed by software, firmware, hardware, or a combination of two or more thereof.

The kernel 141 may control or manage system resources (e.g., the bus 110, the processor 120, and the memory 130) that are used to execute operations or functions implemented in the remaining other programming modules, for example, the middleware 143, the API 145, and the applications 147. Further, the kernel 141 may provide an interface that allows the middleware 143, the API 145, or the applications 147 to access and control or manage individual components of the electronic device 101.

The middleware 143 may serve to mediate between the API 145 or the applications 147 and the kernel 141, that is, allow the API 145 or the application 147 to communicate and exchange data with the kernel 141. Further, the middleware 143 may control (e.g., scheduling or load balancing) for task requests received from the applications 147 by using, for example, a method of assigning a priority for use of the system resource (e.g., the bus 110, the processor 120, or the memory 130) of the electronic device 101 to at least one of the applications 147.

The API 145 is an interface for allowing the applications 147 to control functions provided by the kernel 141 and the middleware 143. The API 145 may include at least one interface or function (e.g., instruction), such as, for example, a file control function, a window control function, an image processing function, or a text control function.

According to various embodiments of the present invention, the applications 147 may include a short message service (SMS)/multimedia messaging service (MMS) application, an e-mail application, a calendar application, an alarm application, a health care application (e.g., an application for measuring an amount of exercise or blood glucose level of a user), and/or an environmental information application (e.g., an application for providing atmospheric pressure information, humidity information, temperature information, and the like). Additionally or alternatively, the applications 147 may include an application associated with information exchange between the electronic device 101 and an external electronic device (e.g., the electronic device 104). An application associated with information exchange, for example, may include a notification relay application for transferring specific information to the external electronic device or a device management application for managing the external electronic device.

For example, the notification relay application may include a function for transferring notification information that is generated in another application of the electronic device 101 (e.g., the SMS/MMS application, the e-mail application, the health care application, or the environmental information application), to an external electronic device 104. Additionally or alternatively, the notification relay application may receive notification information from an external electronic device 104 and provide the received notification information to a user. The device management application may manage (e.g., install, remove, or update) a function for at least a part of an external electronic device 104 communicating with the electronic device 101 (e.g., a function of turning on/off an external electronic device itself (or some components thereof) or adjusting the brightness (or resolution) of a display), an application running on the external electronic device, or a service provided in the external electronic device (e.g., a calling or messaging service).

According to various embodiments, the applications 147 may include an application specified according to an attribute (e.g., type) of an external electronic device 104. For example, when the external electronic device is an MP3 player, the applications 147 may include an application associated with music playback. Similarly, when the external electronic device is a mobile medical device, the applications 147 may include an application associated with health care. According to an embodiment of the present invention, the applications 147 may include at least one of an application assigned to the electronic device 101 and an application received from a server 106 or the electronic device 104.

The input/output interface 150, for example, may transfer instructions or data, input from a user through an input/output device (e.g., a sensor, a keyboard, or a touch screen), to the processor 120, the memory 130, the communication interface 170, or the application control module through the bus 110. For example, the input/output interface 150 may provide the processor 120 with data corresponding to a user's touch input through a touch screen. Further, the input/output interface 150 may, for example, receive instructions or data from the processor 120, the memory 130, the communication interface 170, or the application control module through the bus 110 and output the received instructions or data through the input/output device (e.g., a speaker or a display). For example, the input/output interface 150 may output voice data processed by the processor 120 to a user through a speaker.

The display 160 may display various pieces of information (e.g., multimedia data or text data) to a user.

The communication interface 170 may establish communication between the electronic device 101 and the electronic device 104 or the server 106. For example, the communication interface 170 may connect to the network 162 through a wireless or wired communication link and thereby communicate with the external device. The wireless communication, for example, may include wireless fidelity (WiFi), Bluetooth (BT), near field communication (NFC), a global positioning system (GPS), and/or cellular communication (e.g., long-term evolution (LTE), LTE-Advanced (LTE-A), code division multiple access (CDMA), universal mobile telecommunications system (UMTS), wireless broadband (WiBro), and/or global system for mobile communications (GSM). Examples of the wired communication may include a universal serial bus (USB), a high definition multimedia interface (HDMI), recommended standard 232 (RS-232), and/or a plain old telephone service (POTS).

According to an embodiment, the network 162 may be a telecommunications network. The telecommunications network may include, for example, a computer network, the Internet, the Internet of things, and/or a telephone network. According to an embodiment of the present invention, a protocol (e.g., a transport layer protocol, a data link layer protocol, or a physical layer protocol) for communication between the electronic device 101 and an external device may be supported by at least one of the applications 147, the application programming interface 145, the middleware 143, the kernel 141, and/or the communication interface 170.

The application control module may process at least some pieces of information acquired from other components, including the processor 120, the memory 130, the input/output interface 150, and the communication interface 170) and provide the processed information to a user in various ways.

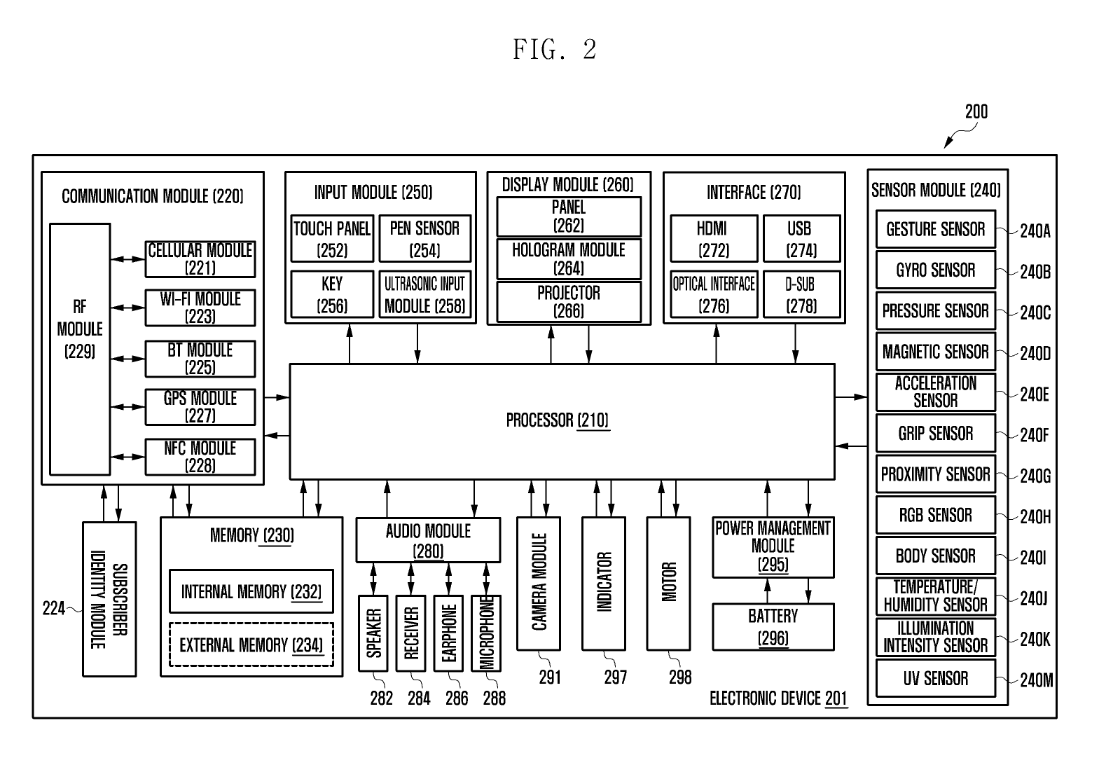

FIG. 2 is a block diagram illustrating an electronic device according to various embodiments of the present invention. The electronic device of FIG. 2, may form all or a part of the electronic device 101 shown in FIG. 1.

Referring to FIG. 2, the electronic device 200 includes at least one application processor (AP) 210, a communication module 220, at least one subscriber identity module (SIM) card 224, a memory 230, a sensor module 240, an input module 250, a display module 260, an interface 270, an audio module 280, a camera module 291, a power management module 295, a battery 296, an indicator 297, and a motor 298.

The AP 210 may drive an operating system or an application program to control hardware and/or software components connected to the AP 210, and the AP 210 may process and operate on various data including multimedia data. The AP 210, for example, may be implemented as a system on chip (SoC). According to an embodiment of the present invention, the AP 210 may further include a graphic processing unit (GPU).

The communication module 220 (e.g., the communication interface 160) may perform data transmission/reception in communication with other electronic devices (e.g., the electronic device 104 and the server 106) connected to the electronic device 200 (e.g., the electronic device 101) through a network. The communication module 220 includes, for example, a cellular module 221, a WiFi module 223, a BT module 225, a GPS module 227, an NFC module 228, and a radio frequency (RF) module 229.

The cellular module 221 may provide a voice call, a video call, an SMS service, an Internet service, and the like through a communication network (e.g., LTE, LTE-A, CDMA, WCDMA, UMTS, WiBro, or GSM). The cellular module 221 may also identify and authenticate an electronic device in a communication network by using, for example, a subscriber identification module (e.g., a SIM card 224). According to an embodiment of the present invention, the cellular module 221 may perform at least some of the functions that may be provided by the AP 210. For example, the cellular module 221 may perform at least a multimedia control function.

According to an embodiment of the present invention, the cellular module 221 may include a communication processor (CP). Further, the cellular module 221, for example, may be implemented as an SoC. Although the cellular module 221 (e.g., a CP), the memory 230, the power management module 295, and the like are shown as separate elements from the AP 210 in FIG. 2, the AP 210 may include any of (e.g., the cellular module 221) of the aforementioned elements according to an embodiment of the present invention.

According to an embodiment of the present invention, the AP 210 or the cellular module 221 (e.g., a CP) may load a command or data received from at least one of a non-volatile memory and other elements connected thereto, into a volatile memory and process the loaded command or data. Further, the AP 210 or the cellular module 221 may store data received from or generated by at least one of other elements in a non-volatile memory.

Each of the WiFi module 223, the BT module 225, the GPS module 227, and the NFC module 228, for example, may include a processor for processing data transmitted or received through the corresponding module. Although the cellular module 221, the WiFi module 223, the BT module 225, the GPS module 227, and the NFC module 228 are shown as separate blocks in FIG. 2, two or more of the cellular module 221, the WiFi module 223, the BT module 225, the GPS module 227, and the NFC module 228 may be included in one integrated chip (IC) or one IC package according to an embodiment of the present invention. For example, some of processors corresponding to the cellular module 221, the WiFi module 223, the BT module 225, the GPS module 227, and the NFC module 228, respectively, (e.g., a CP corresponding to the cellular module 221 and a WiFi processor corresponding to the WiFi module 223) may be implemented as one SoC.

The RF module 229 may perform data transmission/reception, for example, RF signal transmission/reception. Although not shown in FIG. 2, the RF module 229, for example, may include a transceiver, a power amp module (PAM), a frequency filter, a low noise amplifier (LNA), and the like. Also, the RF module 229 may further include a component for transmitting/receiving an electromagnetic wave over the air in wireless communication, such as a conductor or a conducting wire. Although, as shown in FIG. 2, the cellular module 221, the WiFi module 223, the BT module 225, the GPS module 227, and the NFC module 228 share one RF module 229, the cellular module 221, the WiFi module 223, the BT module 225, the GPS module 227, and/or the NFC module 228 may perform RF signal transmission/reception through a separate RF module according to an embodiment of the present invention.

The SIM card 224 may be inserted into at least one slot formed in a certain position of the electronic device. The SIM card 224 may include unique identification information (e.g., an integrated circuit card identifier (ICCID)) or subscriber information (e.g., an international mobile subscriber identity (IMSI)).

The memory 230 (e.g., the memory 130 of FIG. 1) includes, for example, an internal memory 232 and an external memory 234. The internal memory 232, for example, may include a volatile memory (e.g., a dynamic RAM (DRAM), a static RAM (SRAM), or a synchronous dynamic RAM (SDRAM)) and/or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or an NOR flash memory).

According to an embodiment of the present invention, the internal memory 232 may be a solid state drive (SSD). The external memory 234 may further include a flash drive, such as a compact flash (CF), a secure digital (SD), a micro secure digital (Micro-SD), a mini secure digital (Mini-SD), an extreme digital (xD), or a memory stick. The external memory 234 may be functionally connected to the electronic device 200 through various interfaces. According to an embodiment of the present invention, the electronic device 200 may further include a storage device (or storage medium), such as a hard drive.

The sensor module 240 may measure a physical quantity or detect an operation state of the electronic device 200 and convert the measured or detected information into an electronic signal. The sensor module 240 includes, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, a light sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris scanner, and/or a fingerprint sensor. The sensor module 240 may further include a control circuit for controlling one or more sensors included therein.

The input module 250 includes, for example, a touch panel 252, a (digital) pen sensor 254, a key 256, or an ultrasonic input unit 258. The touch panel 252 that recognizes a touch input, for example, may include at least one of a capacitive touch panel, a resistive touch panel, an infrared touch panel, and an acoustic wave touch panel. The touch panel 252 may also include a control circuit. When the touch panel 252 is a capacitive touch panel, the touch panel 252 may recognize a physical contact or proximity. The touch panel 252 may also include a tactile layer, and in order to provide a tactile response to a user.

The (digital) pen sensor 254, for example, may be implemented in a manner similar to a device for receiving a touch input from a user or using a separate recognition sheet. The key 256, for example, may include a physical button, an optical key, or a keypad. The ultrasonic input unit 258 can identify data by generating an ultrasonic signal through an input tool and detecting a sonic wave through the microphone 688 in the electronic device 600, and is capable of wireless recognition. According to an embodiment of the present invention, the electronic device 200 may also receive a user input from an external device (e.g., computer or server) connected thereto by using the communication module 220.

The display 260 (e.g., the display 150) includes, for example, a panel 262, a hologram unit 264, or a projector 266. The panel 262 may be a liquid crystal display (LCD) or an active matrix-organic light emitting diode (AM-OLED). The panel 262 may be implemented to be flexible, transparent, or wearable. The panel 262 may also be incorporated into one module together with the touch panel 252. The hologram unit 264 may show a stereoscopic image in the air by using light interference. The projector 266 may display an image by projecting light onto a screen. The screen, for example, may be located inside or outside of the electronic device 200. According to an embodiment of the present invention, the display 260 may further include a control circuit for controlling the panel 262, the hologram unit 264, or the projector 266.

The interface 270 includes, for example, a high-definition multimedia interface (HDMI) 272, a universal serial bus (USB) 274, an optical interface 276, or a D-subminiature (D-sub) 278. The interface 270 may be included in the communication interface 160 shown in FIG. 1. Additionally or alternatively, the interface 290 may include a mobile high-definition link (MHL) interface, a secure digital (SD) card/multimedia card (MMC) interface, and/or an infrared data association (IrDA) interface.

The audio module 280 may provide bidirectional conversion between a sound and an electronic signal. At least some elements of the audio module 280, for example, may be included in the input/output interface 140 shown in FIG. 1. The audio module 280, for example, may process sound information input or output through a speaker 282, a receiver 284, earphones 286, or the microphone 288.

The camera module 291 is a device that can take both still and moving images, and according to an embodiment of the present invention, may include one or more image sensors (e.g., a front sensor or a rear sensor), a lens, an image signal processor (ISP), or a flash (e.g., an LED or xenon lamp, not shown).

The power management module 295 may manage power of the electronic device 200. Although not shown, the power management module 295, for example, may include a power management integrated circuit (PMIC), a charger IC, or a battery gauge.

The PMIC, for example, may be mounted in an IC or an SoC semiconductor. Charging methods may be classified into wired charging and wireless charging. The charger IC may charge a battery, and may prevent an overvoltage or excess current from being induced or flowing from a charger. According to an embodiment of the present invention, the charger IC may include a charger IC for at least one of wired charging and wireless charging. Examples of wireless charging include magnetic resonance charging, magnetic induction charging, and electromagnetic charging, and an additional circuit such as a coil loop, a resonance circuit, and a rectifier may be added for the wireless charging.

The battery gauge, for example, may measure the residual capacity, charge in voltage, current, or temperature of the battery 296. The battery 296 may store or generate electricity, and may supply power to the electronic device 200 by using the stored or generated electricity. The battery 296, for example, may include a rechargeable battery or a solar battery.

The indicator 297 may display a specific status of the electronic device 200 or a part thereof (e.g., the AP 210), for example, a boot-up status, a message status, or a charging status. The motor 298 may convert an electrical signal into a mechanical vibration. Although not shown, the electronic device 200 may include a processing unit (e.g., GPU) for supporting mobile TV. The processing unit for supporting mobile TV may process media data pursuant to a certain standard, for example, digital multimedia broadcasting (DMB), digital video broadcasting (DVB), or media flow.

Each of the above-described component elements of hardware according to embodiments of the present invention may be configured with one or more components, and the names of the corresponding component elements may vary based on the type of electronic device. In various embodiments of the present invention, the electronic device may include one or more of the above-described elements. Some of the above-described elements may be omitted from the electronic device, and/or the electronic device may include additional elements. Some of the hardware components may be combined into one entity that performs functions identical to those of the relevant components separate components, in accordance with embodiments of the present invention.

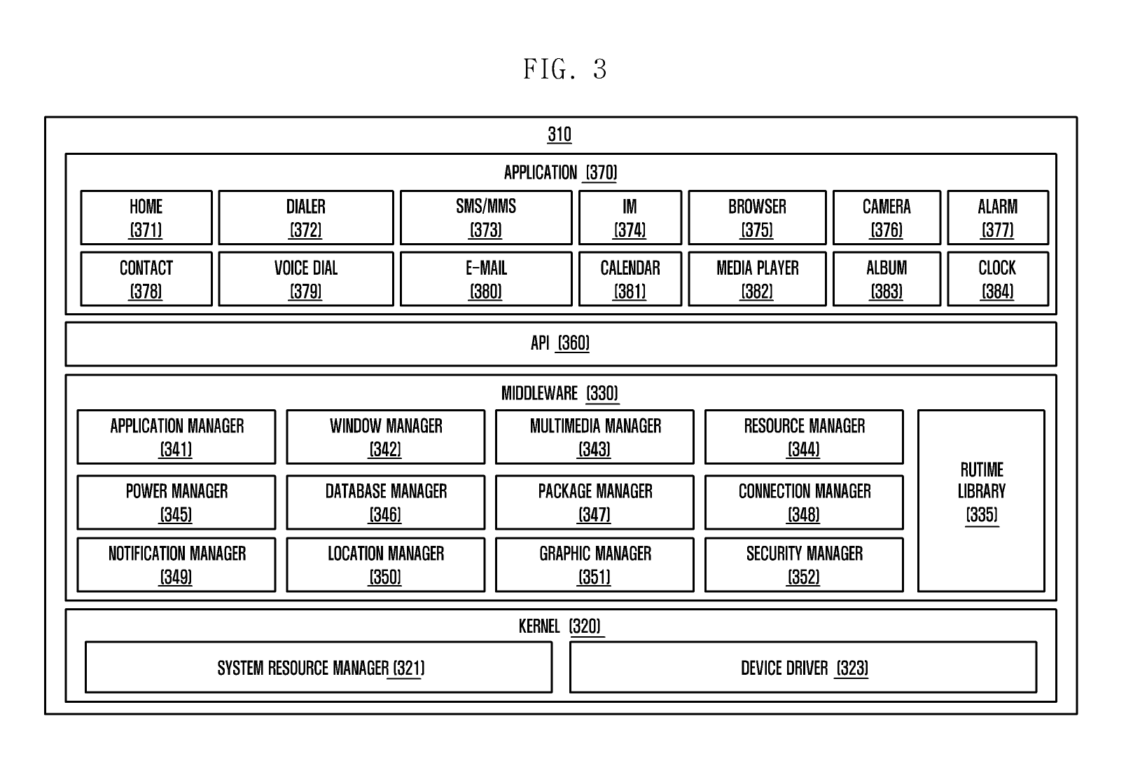

FIG. 3 is a block diagram of a program module according to various embodiments of the present invention.

Referring to FIG. 3, according to an embodiment of the present invention, the program module 310 (for example, the program 140) may include an Operating System (OS) for controlling resources related to the electronic device 101 and/or various applications (for example, the application programs 147) executed in the operating system. The operating system may be, for example, Android, iOS, Windows, Symbian, Tizen, Bada, or the like.

The program module 310 includes a kernel 320, middleware 330, an API 360, and an application 370. At least some of the program module 310 may be preloaded on the electronic apparatus, or may be downloaded from the electronic apparatus 102 or 104, or the server 106.

The kernel 320 (e.g., the kernel 141) includes, for example, a system resource manager 321 and/or a device driver 323. The system resource manager 321 may perform the control, allocation, retrieval, or the like of system resources. According to one embodiment of the present invention, the system resource manager 321 may include a process management unit, a memory management unit, or a file system management unit. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources within the electronic apparatus. According to an embodiment of the present invention, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses to add a new function by using a programming language, during the execution of the application 370. The runtime library 335 may perform input/output management, memory management, the functionality for an arithmetic function, or the like.

The application manager 341 may manage, for example, the life cycle of at least one of the applications 370. The window manager 342 may manage Graphical User Interface (GUI) resources used for the screen. The multimedia manager 343 may determine a format required to reproduce various media files, and may encode or decode a media file by using a coder/decoder (codec) appropriate for the relevant format. The resource manager 344 may manage resources, such as source code, memory, storage space, and the like, of at least one of the applications 370.

The power manager 345 may operate together with a Basic Input/Output System (BIOS) to manage a battery or power and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, a Wi-Fi or Bluetooth connection. The notification manager 349 may display or notify a user of an event, such as an arrival message, an appointment, a proximity notification, and the like, in a manner intended not to disturb the user. The location manager 350 may manage location information of the electronic apparatus. The graphic manager 351 may manage graphic effects to be provided to the user, or a user interface related to the graphic effect. The security manager 352 may provide various security functions required for system security, user authentication, and the like. According to an embodiment of the present invention, when the electronic apparatus 101 has a telephone call function, the middleware 330 may further include a telephony manager for managing a voice call function and/or a video call function of the electronic apparatus.

The middleware 330 may include a middleware module that forms a combination of various functions of the above-described elements. The middleware 330 may provide a module specialized for each type of OS in order to provide a differentiated function.

The API 360 (e.g., the API 145) is, for example, a set of API programming functions, and may be provided with a different configuration according to an OS. For example, when the electronic apparatus runs Android or iOS, one API set may be provided for each platform. When the electronic device runs Tizen, two or more API sets may be provided for each platform.

The applications 370 (for example, the application program 147) may include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar level), or environment information (for example, atmospheric pressure, humidity, or temperature information).

According to an embodiment of the present invention, the applications 370 may include an application (hereinafter, referred to as an “information exchange application” for convenience of description) that supports information exchange between the electronic apparatus 101 and an external electronic apparatus, such as the electronic apparatus 102 or 104. The application associated with information exchange may include, for example, a notification relay application for forwarding specific information to an external electronic device, or a device management application for managing an external electronic device.

For example, the notification relay application may include a function for delivering, to the electronic apparatus 102 or 104, notification information generated by other applications (e.g., an SMS/MMS application, an email application, a health care application, an environmental information application, etc.) of the electronic apparatus. Further, the notification relay application may receive notification information from, for example, an external electronic device and provide the received notification information to a user.

The device management application may manage (for example, install, delete, or update), for example, a function for at least a part of the electronic apparatus 102 or 104 communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment of the present invention, the applications 370 may include applications (for example, a health care application of a mobile medical appliance or the like) designated according to attributes of one or both of the external electronic devices 102 and 104. According to an embodiment of the present invention, the applications 370 may include an application received from an external electronic device, such as the server 106, or one of the electronic devices 102 and 104. According to an embodiment of the present invention, the applications 370 may include a preloaded application or a third party application that may be downloaded from a server. The names of the elements of the program module 310 may vary according to the type of operating system operating in the electronic device that includes the program module 310.

According to various embodiments of the present invention, all or a part of the programming module 310 may be implemented in software, firmware, hardware, or any combination thereof. Some or all of the program module 310 may be implemented (e.g., executed) by, for example, the processor 210. At least some of the program module 310 may include, for example, a module, a program, a routine, a set of instructions, and/or a process for performing one or more functions.

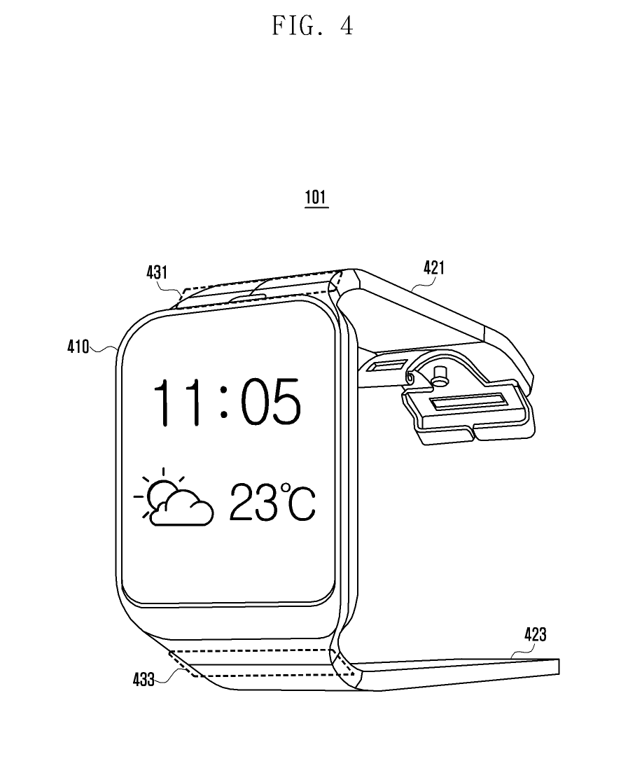

FIG. 4 is a perspective view diagram schematically illustrating an electronic device according to various embodiments of the present invention.

Referring to FIG. 4, an electronic device 101 according to an embodiment of the present invention may be a smartwatch, including a body 410 and one or more accessories. Each accessory may be physically connected to and separated from the body 410. For example, when the electronic device is the illustrated smart watch, the electronic device 101 includes a body 410, a first strap 421, and a second strap 423 for fixing the body 410 to a wrist of the user. The first and second straps 421 and 423 may fix the electronic device 101 to a wrist of the user by various methods. For example, the one or more straps 421 and 423 may be formed of a resilient material and may be mounted on a wrist of the user. The first strap 421 and the second strap 423 may include a fixing unit that may connect and fix the first strap 421 and the second strap 423 after the first strap 421 and the second strap 423 surround a wrist of the user. The straps 421 and 423 may be manufactured by various methods.

In the electronic device 101, according to an embodiment of the present invention, because the first and second straps 421 and 423 may be connected to and separated from the body 410, coupling areas 431 and 433 are formed at parts where the body 410 faces the first and second straps 421 and 423. For example, in the illustrated smart watch, the coupling areas 431 and 433 include connectors of the body 410, and connectors of the first and second straps 421 and 423. According to an embodiment of the present invention, the connectors of the body 410 and the connectors of the first and second straps 421 and 423 may be physically connected to each other, for example, in a mechanical form or according to an electromagnetic connection. According to an embodiment of the present invention, the connectors of the body 410 and the connectors of the first and second straps 421 and 423 may be fixed by a separate coupling unit. For example, the coupling areas 431 and 433 of the electronic device 101 may have a hinge structure.

As described in detail later herein, the connectors of the body 410 and the connectors of the first and second straps 421 and 423 may include conductive contacts at portions of the surfaces thereof. The body 410 and the first and second straps 421 and 423 may transmit and receive electrical signals through conductive contact. For example, the conductive contacts of the connectors of the body 410 and the conductive contacts of the connectors of the first and second straps 421 and 423 may transmit and receive electrical signals through direct connections (for example, contacts).

According to another example, the conductive contacts of the connectors of the body 410 and the conductive contacts of the connectors of the first and second straps 421 and 423 may transmit and receive electrical signals through indirect connections. For example, when the one or more coupling areas 431 and 433 of the electronic device 101 have a hinge structure, the coupling areas 431 and 433 may further include a separate coupling unit for fixing the connectors of the body 410 and the connectors of the first and second straps 421 and 423, for example, a pin. The pin may include a conductive cable therein. As the conductive cable indirectly connects the conductive contacts of the connectors of the body 410 and the conductive contacts of the connectors of the first and second straps 421 and 423, the body 410 and the first and second straps 421 and 423 may transmit and receive electrical signals.

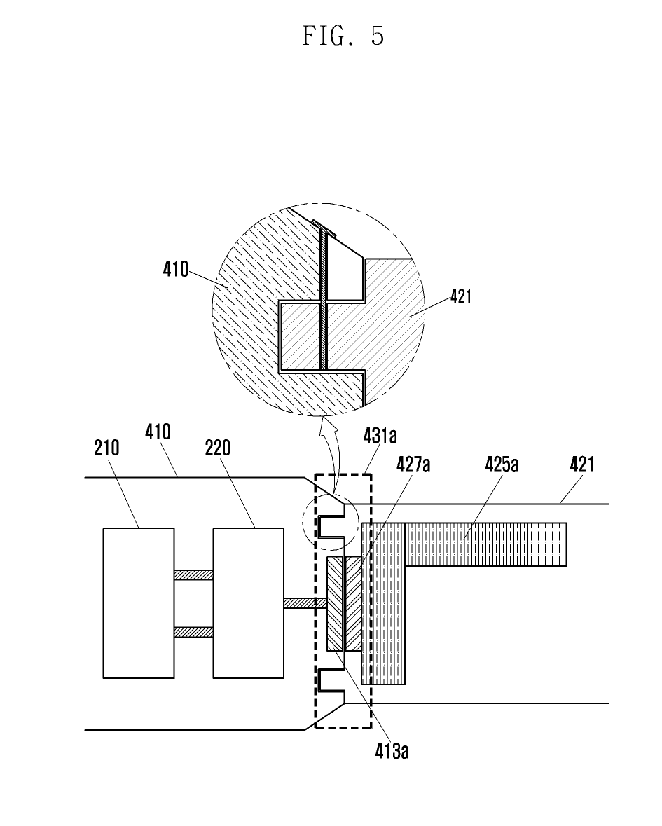

FIGS. 5 to 8 are plan view diagrams schematically illustrating an electronic devices according to various embodiments of the present invention.

Referring to FIG. 5, the electronic device 101 includes a body 410 and straps 421. The body 410 and the straps 421 may be connected to and separated from each other. The body 410 and the straps 421 have coupling areas 431a for physical and electrical connections thereof.

According to an embodiment of the present invention, the body 410 includes a communication module 220, conductive contacts 413a, and a processor 210.

According to an embodiment of the present invention, the processor 210 may include one or more application processors (APs) and a communication processor (CP). The AP may control a plurality of hardware or software components connected to the AP and may perform various data processing and calculations, including multimedia data processing and calculation, by driving an operating system and/or application programs. The APs may be implemented by, for example, a System on Chip (SoC). According to an embodiment of the present invention, the AP may further include a Graphic Processing Unit (GPU). The CP may manage a data link in a communication between the electronic device 101 and other electronic devices connected through a network and converting a communication protocol. The CP may also be implemented by an SoC. The processor 210 according to an embodiment of the present invention may identify a subscriber identity module card connected to a slot, and perform communications through the communication module 220. The processor 210 may identify a frequency band based on the subscriber identity module card.

According to an embodiment of the present invention, the communication module 220 may transmit and receive data of communications between other electronic devices connected to the electronic device 101 through a network. According to an embodiment of the present invention, the communication module 220 may include a Radio Frequency (RF) module, a cellular module, a Wi-Fi module, a BT module, a GPS module, and an NFC module.

The first conductive contacts 413a may be formed on at least one area of a surface of the body 410, for electrical connection with one or more antennas 425a included in the strap 421. The first conductive contacts 413a may transmit an RF signal. Accordingly, the electronic device 101 may transmit and receive an RF signal of the communication module 220 to and from the antennas 425a included in the external strap 421 through the first conductive contacts 413a.

The body 410, according to various embodiments of the present invention, may further include an interface module and an audio processing module.

According to an embodiment of the present invention, the strap 421 includes one or more antennas 425a and one or more second conductive contacts 427a.

The one or more antennas 425a may function as radiation bodies for radiating received electrical signals. According to various embodiments of the present invention, the electronic device 101 according to an embodiment of the present invention may include a plurality of straps, and the straps may include antennas that have different respective frequency characteristics. The user may replace straps connected to the body 410 with straps of desired frequency characteristics. For example, when the body 410 includes separate antennas, any one antenna included in the strap 421 may improve the ground characteristics of an antenna included in the body 410 or another antenna included in the strap 421.

The one or more second conductive contacts 427a may be formed on at least one area of a surface of the strap 421, for electrical connection with the body 410. The one or more second conductive contacts 427a may be connected to one antenna, respectively, as illustrated, and may be connected to one or more antennas.

The one or more second conductive contacts 427a are electrically connected to the one or more first conductive contacts 413a in a direct or indirect manner, so that an RF signal may be transmitted and received between the communication module 220 of the body 410 and the antenna 425a of the strap 421.

The coupling area 431a, in which the body 410 and the strap 421 are connected to each other, includes a physical coupling and an electrical coupling between the body 410 and the strap 421. For example, as illustrated in FIG. 5, the first conductive contact 413a, which is formed on a surface of the body 410, and the second conductive contact 427a, which is formed on a surface of the strap 421, are in contact with each other, so that the body 410 and the strap 421 may be electrically connected to each other. The body 410 and the strap 421 may be physically coupled to each other in a structure that is separable in various manners. For example, as illustrated, the body 410 and the strap 421 may be physically coupled to each other through a hinge structure. The strap 421 may be replaced by removing a pin that fixes the body 410 and the strap 421. The above-described forms of coupling are merely provided as examples, and the body 410 and the strap 421 may be physically coupled to each other in various manners, in accordance with embodiments of the present invention.

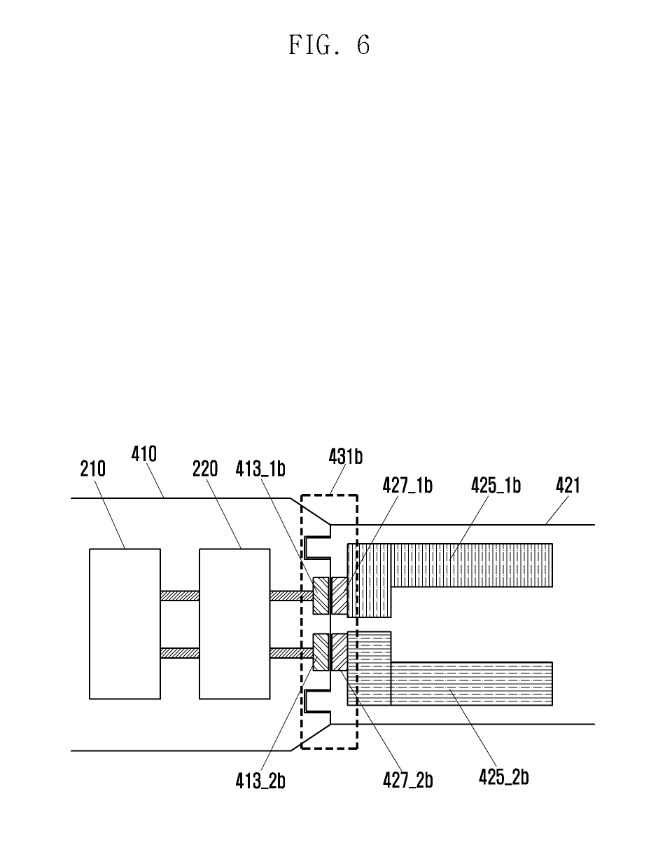

Referring to FIG. 6, according to another embodiment of the present invention, two coupling areas 431_1b and 413_2b include distinguished electrical connection parts between the body 410 and the strap 421. Accordingly, the electronic device 101 may transmit and receive distinguished electrical signals to various parts. According to an embodiment of the present invention, the one or more straps 421 may include two or more separated antennas. In the example of FIG. 6, the strap 421 includes a first antenna 425_1b and a second antenna 425_2b. The first antenna 425_1b may irradiate, for example, a first frequency band, and the second antenna 425_2b may irradiate, for example, a second frequency band. For example, one of the first and second antennas 425_1b and 425_2b may improve the ground characteristics of the other antenna. According to another example, when the body 410 includes a separate antenna, at least one antenna of the first and second antennas 425_1b and 425_2b included in the strap 421 improves the ground characteristics of the antenna included in the body 410. The strap 421 includes a plurality of second conductive contacts 427_1b and 427_2b corresponding to the first and second antennas 425_1b and 425_2b.

The body 410 includes a plurality of first conductive contacts 413_1b and 413_2b corresponding to the plurality of second conductive contacts 427_1b and 427_2b of the strap 421. The first conductive contacts 413_1b and 413 2b are connected to the communication module 220 via separate paths. Accordingly, the electronic device 101 may perform a communication function through various frequency bands when one strap 421 is connected to the electronic device 101. The electronic device 101 can improve the conditions of the antennas, such as the ground characteristics, when the strap 421 is connected to the electronic device 101.

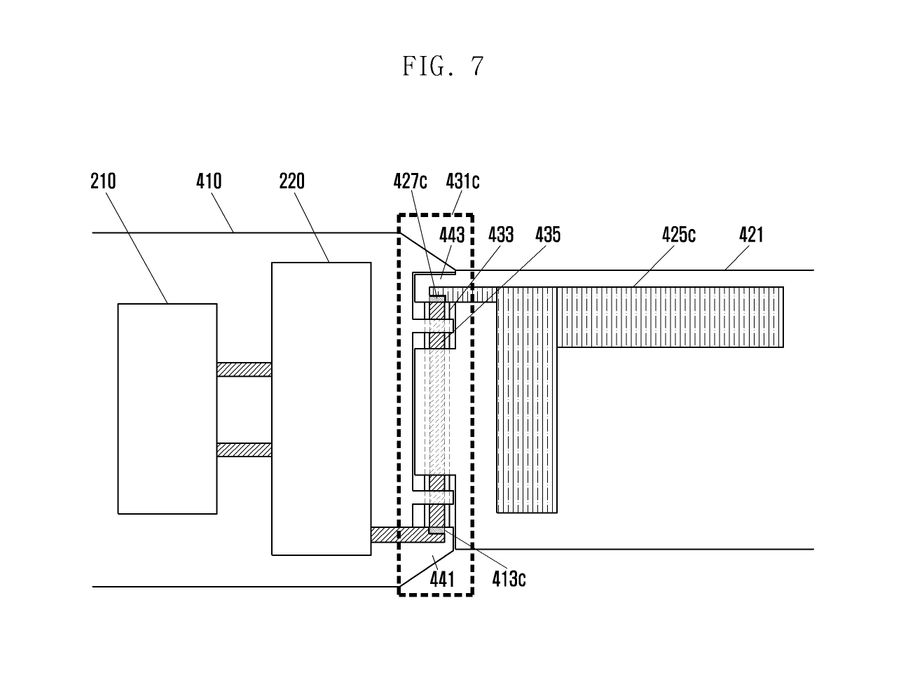

Referring to FIG. 7, according to another embodiment of the present invention, the coupling area 431c of the electronic device 101 may physically and electrically couple the body 410 and the strap 421 through various methods.

Referring to the drawing, the coupling area 431c may have, for example, a hinge structure. The coupling area 431c includes a connector of the body 410, a connector of the strap 421, and one or more coupling units 433 for fixing the two connectors. The coupling unit 433 may include, for example, a pin. The connectors of the body 410 and the strap 421 may include a hinge arm that may be fixed by a pin. As illustrated, the hinge arms of the body 410 and the strap 421 includes supports 441 and 443 for supporting ends of the fixed pin. The support 441 of the body 410 may have a first conductive contact 413c in an area in contact with one end of the pin. The support 443 of the strap 421 may have a second conductive contact 427c in an area in contact with an opposite end of the pin. In addition to the illustrated example, the hinge arm may be achieved through various methods of fixing a pin. According to various embodiments of the present invention, the pin may have a straight linear shape, or may include a bent portion. The connectors of the body 410 and the strap 421 may be formed of a resilient material. Accordingly, the body 410 and the strap 421 may be separated by removing a coupling unit 433 fixed to the body 410 and the strap 421 using resiliency.

The coupling unit 433 according to an embodiment of the present invention (e.g., a pin) includes a conductive cable 435 therein. The conductive cable 435 may perform a function of transmitting an RF signal without performing the function of a radiation body. For example, opposite ends of the conductive cable 435 may be exposed at opposite ends of the pin. The conductive cable 435 exposed at any one end of the pin may be connected to, for example, make contact with the first conductive contact 413c formed on a surface of the connector of the body 410. The conductive cable 435 exposed at an opposite end of the pin may be connected to, for example, make contact with the second conductive contact 427c formed on a surface of the connector of the body 421. Accordingly, the communication module 220 of the body 410 may transmit and receive an RF signal to and from the antenna 425c of the strap 421.

According to various embodiments of the present invention, each of the connectors of the body 410 and the strap 421 may include two or more conductive contacts. Although not illustrated in FIG. 7, the coupling unit 435 may include two or more signal transmission paths. For example, the coupling unit 435 may include two or more conductive cables. The conductive cables may be connected to the corresponding conductive contacts of the body 410 and the strap 421 in order to transmit different RF signals through two or more paths.

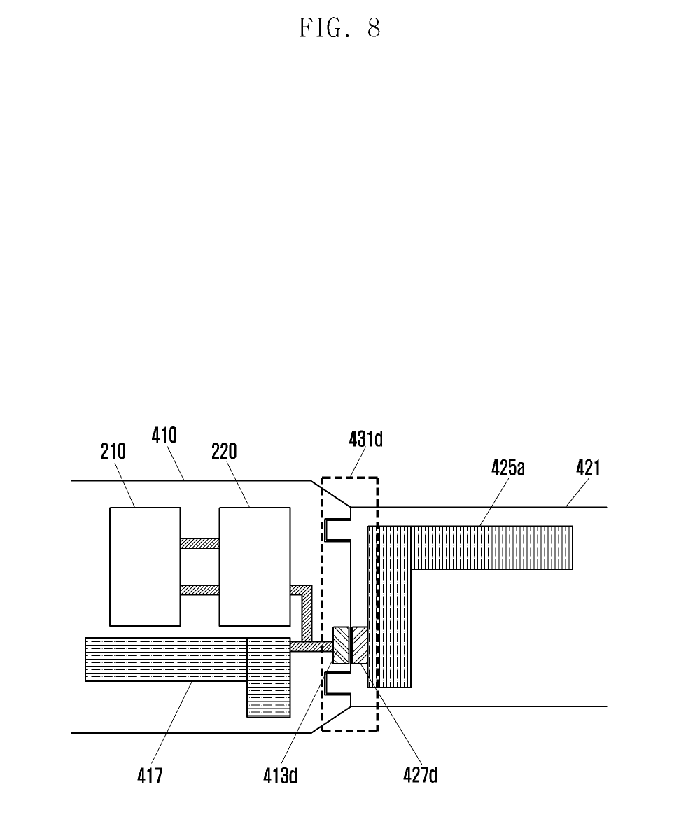

Referring to FIG. 8, the electronic device 101 includes antennas 417 and 425a in the body 410 and the strap 421. In order to perform a particular function, the electronic device 101 may require, for example, an antenna that has the characteristics of a relatively high frequency band and an antenna that has the characteristics of a relatively low frequency band. Generally, lower frequency bands require larger antennas. For example, because the body 410 includes various modules, the body 410 may not include sufficient space for certain antennas for lower frequency bands. Accordingly, according to an embodiment of the present invention, the body 410 may include an antenna 417 that has the characteristics suitable for communication via a relatively high frequency band, and the strap 421 may include an antenna 425a that has the characteristics suitable for communication via a relatively low frequency band. The antenna 425a included in the strap 421 may transmit and receive an RF signal to and from the communication module 220 through a coupling area 431d. The coupling area 431d may include a first conductive contact 413d of the body 410 and a second conductive contact 427d of the strap 421. The first conductive contact 413d may be electrically connected to the second conductive contact 427d directly or indirectly. According to another embodiment of the present invention, the electronic device 101 may electrically connect the antenna 425a included in the strap 421 to the antenna 417 included in the body 410 in order to change the condition of the antennas, such as the ground characteristics.

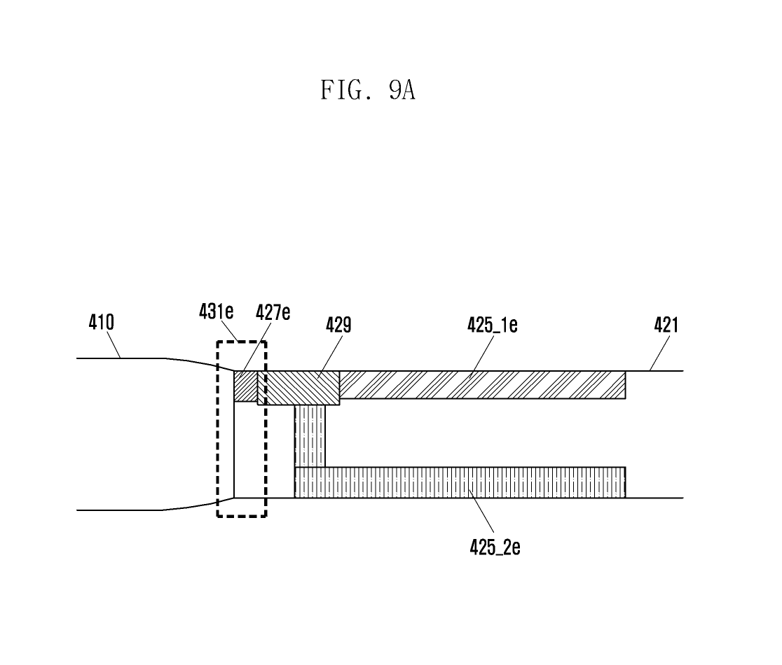

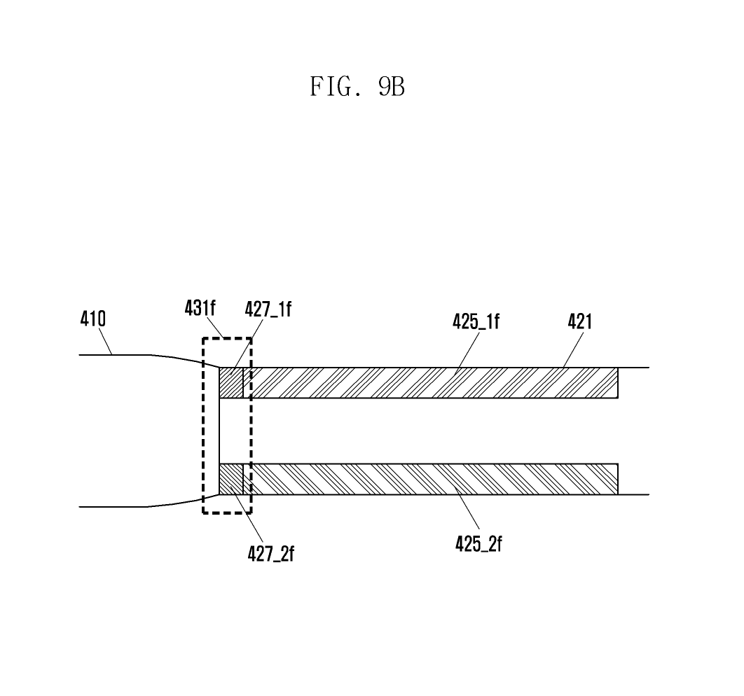

FIGS. 9A and 9B are side view diagrams schematically illustrating electronic devices according to various embodiments of the present invention. FIGS. 9A and 9B illustrate an arrangement structure in which a strap includes two antennas.

Referring to FIG. 9A, a strap 421 of an electronic device includes first and second antennas 425_1e and 425_2e. The first and second antennas 425_1e and 425_2e may perform different functions. For example, the first and second antennas 425_1e and 425_2e may have different frequency band characteristics. In order to minimize mutual influences, the first antenna 425_1e may be formed, for example, on an upper surface of the strap 421 and the second antenna 425_2e may be formed, for example, a lower surface of the strap 421. The body 410 and the strap 421 of the electronic device 101 are physically and electrically connected to each other by the coupling area 431e. According to an embodiment of the present invention, the strap 421 may allow the first and second antennas 425_1e and 425_2e to transmit and receive RF signals to and from a communication module of the body 410 through a one second conductive contact 427e. The strap 421 includes a filter element 429 that selectively connects the first and second antennas 425_1e and 425_2e to the second conductive contact 427e, for transmitting and receiving an RF signal. The filter element 429 is used when it is difficult to realize a plurality of frequency bands with one antenna. The filter element 429 may include, for example, a diplexer, a triplexer, and/or a quadplexer, and may distinguish different frequency bands provided by a plurality of antennas. As an example, when a power may be used, the filter element 429 may select a frequency band, for example, using a switch.

Referring to FIG. 9B, according to another embodiment of the present invention, the strap 421 of the electronic device 101 includes first and second antennas 425_1f and 425_2f. In order to minimize mutual influences, the first antenna 425_1f may be formed, for example, on an upper surface of the strap 421 and the second antenna 425_2f may be formed, for example, on a lower surface of the strap 421. As described above, the body 410 and the strap 421 of the electronic device 101 may be physically and electrically connected to each other by the coupling area 431f. According to the embodiment of the present invention, the strap 421 includes second conductive contacts 427_1f and 427_2f corresponding to the number of antennas included in the strap 421. The first antenna 425_1f may transmit and receive an RF signal to and from a communication module of the body 410 through the second conductive contact 427_1f corresponding to the first antenna 425_1f. The second antenna 425_2f may transmit and receive an RF signal to and from a communication module of the body 410 through the second conductive contact 427_2f corresponding to the second antenna 425_2f.

In this way, according to various embodiments of the present invention, the electronic device 101 may realize multifunctional antennas using opposite surfaces of the strap 421.

The term “module” as used herein may, for example, refer to a unit including one of hardware, software, and firmware or a combination of two or more of them. The term “module” may be interchangeably used with, for example, the terms “unit”, “logic”, “logical block”, “component”, and/or “circuit”. The term “module” may refer to a minimum unit of an integrated component element or a part thereof The term “module” may be a minimum unit for performing one or more functions or a part thereof A module may be mechanically or electronically implemented. For example, a module according to an embodiment of the present invention may include an Application-Specific Integrated Circuit (ASIC) chip, a Field-Programmable Gate Arrays (FPGA), and a programmable-logic device for performing operations which has been known or are to be developed hereinafter.

According to various embodiments of the present invention, one or more devices (e.g., modules or functions thereof) or a method (e.g., operations) may be implemented by a command stored in a computer-readable storage medium in a programming module form. An instruction, when executed by a processor (e.g., the processor 120), may cause one or more processors to execute a function corresponding to the instruction. The computer-readable storage medium may be, for example, the memory 130.

The computer readable recording medium may include a hard disk, a floppy disk, magnetic media (for example, a magnetic tape), optical media (for example, a compact disc (CD)-read only memory (ROM) (CD-ROM) and a Digital Versatile Disc (DVD)), magneto-optical media (for example, a floptical disk), a hardware device (for example, a Read Only Memory (ROM), a Random Access Memory (RAM), a flash memory), and the like. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present invention, and vice versa.

Any of the modules or programming modules according to various embodiments of the present invention may include at least one of the above described elements, exclude some of the elements, or further include other additional elements. The operations performed by the modules, programming module, or other elements according to various embodiments of the present invention may be executed in a sequential, parallel, repetitive, or heuristic manner. Further, some operations may be executed according to another order or may be omitted, or other operations may be added.

An electronic device according to an embodiment of the present invention can provide an antenna that has excellent performance, in spite of spatial restrictions, such as restrictions in wearable electronic devices.

Furthermore, an electronic device according to an embodiment of the present invention can provide an improved communication function, because the antennas that have various frequency characteristics can be connected to each other simultaneously or alternatively.

In addition, an electronic device according to an embodiment of the present invention can replace an antenna included in a strap, with another antenna included in another strap in order to address problems generated during roaming from a network requiring an antenna with certain characteristics to another network requiring an antenna with other characteristics.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. An electronic device comprising:
a body comprising:
a communication module, and
at least one first conductive contact configured to transmit electrical signals to and receive electrical signals from the communication module; and
at least one strap removably connected to the body, the at least one strap comprising:
an antenna therein, and
at least one second conductive contact configured to transmit electrical signals to and receive electrical signals from the antenna,
the one strap being configured to removably connect to the body, such that at least a portion of the at least one first conductive contact is electrically connected to the at least one second conductive contact.

2. The electronic device of claim 1, wherein the body further comprises a first connector, the strap further comprises a second connector, and the electronic device further comprises at least one coupling unit configured to removably couple the first connector to the second connector.

3. The electronic device of claim 2, wherein the at least a portion of the at least one first conductive contact is formed in the first connector, and the at least a portion of the at least one second conductive contact is formed in the second connector.

4. The electronic device of claim 3, wherein the at least one coupling unit comprises a conductive cable, and the at least a portion of the at least one first conductive contact is electrically connected to the at least a portion of the at least one second conductive contact.

5. The electronic device of claim 1, wherein the body further comprises a body antenna electrically connected to the communication module, the body antenna having characteristics different from the antenna included in the at least one straps.

6. The electronic device of claim 5, wherein the communication module is configured to implement various antenna characteristics via an interworking of the body antenna and the antenna of the at least one strap.

7. The electronic device of claim 1, wherein the at least one strap comprises:
a first antenna provided on an upper surface of the at least one strap; and
a second antenna having characteristics different from characteristics of the first antenna, the second antenna being provided on a lower surface of the at least one strap.

8. The electronic device of claim 7, wherein the at least one strap further comprises a filter element that electrically connects the first antenna and the second antenna to any one of the at least one second conductive contacts.

9. The electronic device of claim 7, wherein the first antenna is electrically connected to one of the at least one second conductive contact and the second antenna is electrically to another one of the at least one second conductive contact.

10. An electronic device comprising:
a body comprising:
a communication module, and
a first connector having at least one conductive contact configured to transmit electrical signals to and receive electrical signals from the communication module;
at least one strap comprising:
an antenna, and
a second connector having at least one second conductive contact configured to transmit electrical signals to and receive electrical signals from the antenna; and
a coupling unit configured to removably couple the first and second connectors, and further configured to electrically connect at least a portion of the at least one first conductive contact to at least a portion of the at least one second conductive contact.

11. The electronic device of claim 10, wherein the coupling unit is a pin comprising a conductive cable.

12. The electronic device of claim 11, wherein the first connector comprises a first hinge arm, the second connector comprises a second hinge arm, and each of the first and second hinge arms comprises a support configured to receive a respective end of the pin.

13. The electronic device of claim 12, wherein the support of the first connector comprises the first conductive contact configured to contact an end of the pin received by the support of the first connector, and the support of the second connector comprises the second conductive contact configured to contact an opposite end of the pin received in the support of the second contact connector.

14. The electronic device of claim 10, wherein the body comprises a body antenna connected to the communication module, the body antenna having characteristics different from characteristics the antenna included in the at least one strap.

15. The electronic device of claim 14, wherein the communication module is configured to implement various antenna characteristics via an interworking of the body antenna and the antenna of the at least one strap.

16. The electronic device of claim 10, wherein the at least one strap comprises:
a first antenna provided on an upper surface of the at least one strap; and
a second antenna having characteristics different from characteristics of the first antenna, the second antenna being provided on a lower surface of the at least one strap.

17. The electronic device of claim 16, wherein the at least one strap further comprises a filter element that electrically connects the first antenna and the second antenna to any one of the at least one second conductive contact.

18. The electronic device of claim 16, wherein the first antenna is electrically connected to one of the at least one second conductive contact and the second antenna is electrically connected to another one of the at least one second conductive contact.

19. The electronic device of claim 16, wherein the first antenna is included in one of the at least one strap, and
the second antenna is included in another one of the at least one strap.

20. The electronic device of claim 10, wherein the antenna is included in one of the at least one strap, and
another one of the at least one strap comprises a second antenna having characteristics different from characteristics of the first antenna.
